(19) United States
(12) Patent Application Publication
(10) Pub. No.: US 2015/0095845 A1
(43) Pub. Date: Apr. 2, 2015

(54) ELECTRONIC DEVICE AND METHOD FOR PROVIDING USER INTERFACE IN ELECTRONIC DEVICE

(71) Applicant: Samsung Electronics Co., Ltd., Gyeonggi-do (KR)

(72) Inventors: Bong-Su CHUN, Gyeonggi-do (KR); Hee-Tae Kim, Gyeonggi-do (KR); Kyung-Soo Seo, Seoul (KR); Jeong-Mo Ahn, Gyeongg-do (KR); Ji-Hwan Lim, Gyeonggi-do (KR); Ku-Chul Jung, Seoul (KR)

(73) Assignee: Samsung Electronics Co., Ltd., Gyeonggi-do (KR)

(21) Appl. No.: 14/221,417

(22) Filed: Mar. 21, 2014

(30) Foreign Application Priority Data
Sep. 30, 2013 (KR) 10-2013-0116159

(51) Int. Cl. G06F 3/0485; G06F 3/0488; G06F 3/0481

(52) U.S. Cl. CPC G06F 3/0485; G06F 3/0481; G06F 3/0488
USPC 715/784; 715/781; 715/790

(57) ABSTRACT

Provided is an electronic device including an inputtable display that is divided into a first region and a second region in a first mode in which a layer for displaying data of the first region is displayed on the second region and a controller configured to identically apply an event occurring on the layer to the first region of the display, upon occurrence of the event on the layer.

### PRIORITY

This application claims priority under 35 U.S.C. §119(a) to Korean Patent Application Serial No. 10-2013-0116159, which was filed in the Korean Intellectual Property Office on Sep. 30, 2013, the entire content of which is incorporated herein by reference.

### BACKGROUND OF THE INVENTION

1. Field of the Invention

The present invention generally relates to an electronic device and a method for providing a User Interface (UI), and more particularly, to an electronic device that provides a UI to a user for the user to search for data in the electronic device, and a method for providing the UI in the electronic device.

2. Description of the Related Art

Users may take a touch or scrolling action on a display of an electronic device to search for desired data. When searching for the desired data, the user may perform the scrolling action on the display. A touch input may then be made when a direct touch is made on a particular portion on the display, such that the user may see the desired data by directly touching the particular portion.

When the user holds the electronic device with one hand, the user may search for the data by performing the scrolling action with the other hand. For example, if a scroll-down action occurs on the display, screen scrolling (or screen movement) on the display corresponding to the scroll-down action may be performed. However, when the screen of the display reaches the topmost position of the display, screen scrolling on the display corresponding to the scroll-down action does not be performed any longer. If the user intends to touch data situated in the topmost position of the display, the user who controls the electronic device with one hand may find it inconvenient to directly touch the data.

### SUMMARY OF THE INVENTION

The present invention has been made to address at least the problems and disadvantages described above and to provide at least the advantages described below.

Accordingly, an aspect of the present invention is to provide an electronic device that provides a User Interface (UI) for the user to conveniently search for data in the electronic device and a method for providing the UI in the electronic device.

Another aspect of the present invention is to provide an electronic device that provides a UI for the user to easily search for data with one hand and a method for providing the UI in the electronic device.

According to an aspect of the present invention, an electronic device is provided including an inputtable display that is divided into a first region and a second region in a first mode in which a layer for displaying data of the first region is displayed on the second region and a controller configured to identically apply an event occurring on the layer to the first region of the display, upon occurrence of the event on the layer.

According to another aspect of the present invention, an electronic device is provided including a display having an input function and a controller configured to divide and display the display into a first region and a second region, display data, which is displayed on the first region, on the second region, and display data corresponding to an input on the second region on the display.

According to another aspect of the present invention, a method for providing a User Interface (UI) in an electronic device is provided including displaying, in a first mode in which a display is divided into a first region and a second region, a layer for displaying data of the first region on the second region, and identically applying an event occurring on the layer on the first region of the display, upon occurrence of the event on the layer.

According to another aspect of the present invention, a method for providing a User Interface (UI) in an electronic device is provided including displaying data, which is displayed on a first region, on a second region when a display is divided into and displayed as the first region and the second region, and displaying on the display data corresponding to an input on the second region.

### BRIEF DESCRIPTION OF THE DRAWINGS

The above and other aspects, features and advantages of certain embodiments of the present invention will be more apparent from the following detailed description taken in conjunction with the accompanying drawings, in which:

FIG. 1 is a block diagram illustrating an electronic device according to an embodiment of the present invention;

FIGS. 2A and 2B are flowcharts illustrating a process of providing a User Interface (UI) in an electronic device according to an embodiment of the present invention;

FIGS. 3A and 3B illustrate a process of providing a UI on a web page screen of an electronic device according to an embodiment of the present invention;

FIGS. 4A and 4B illustrate a process of providing a UI on a menu screen of an electronic device according to an embodiment of the present invention;

FIG. 5 is a flowchart illustrating a process of providing another UI in an electronic device according to an embodiment of the present invention;

FIGS. 6A and 6B are flowcharts illustrating a process of providing a menu of a quick panel on a UI in an electronic device according to an embodiment of the present invention; and

FIGS. 7A and 7B illustrate a process of providing a menu of a quick panel on a UI in an electronic device according to an embodiment of the present invention.

Throughout the drawings, like reference numerals will be understood to refer to like parts, components, and structures and the reference numerals are used to describe components and features.

### DETAILED DESCRIPTION OF EMBODIMENTS OF THE PRESENT INVENTION

The following description referring to the accompanying drawings is provided to help the overall understanding of various embodiments of the present invention defined in claims and equivalents thereof. While the following description includes various specific details to help the understanding, it will be regarded merely as examples. Therefore, those of ordinary skill in the art may recognize that various changes and modifications may be made to the embodiments described herein without departing fro the scope and spirit of the present invention.

Hereinafter, the present invention will be described with reference to accompanying drawings. In the description of the present invention, if it is determined that a detailed description of commonly-used technologies or structures related to the invention may unnecessarily obscure the subject matter of the invention, the detailed description will be omitted. Terms to be described below have been defined by considering functions in embodiments of the present invention, and may be defined differently depending on a user or operator's intention or practice. Therefore, the definitions of such terms will be based on the descriptions of the entire present specification.

The terms and words used in the following description and claims are not limited to their dictionary meanings, but, are merely used to enable a clear and consistent understanding of the invention. Accordingly, it should be apparent to those skilled in the art that the following description of certain embodiments of the present invention is provided for illustration purposes only and not for the purpose of limiting the invention, as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

An electronic device according to various embodiments of the present invention may be a device including a communication function. For example, the electronic device may be a combination of one or more of devices such as a smartphone, a tablet Personal Computer (PC), a mobile phone, a video phone, an electronic-book reader, a desktop PC, a laptop PC, a netbook computer, a Personal Digital Assistant (PDA), a Portable Multimedia Player (PMP), an MP3 player, mobile medical equipment, an electronic bracelet, an electronic necklace, an electronic accessory, a camera, a wearable device, an electronic clock, a wrist watch, a home appliance (for example, a refrigerator, an air conditioner, a cleaner, an oven, a microwave oven, a washing machine, an air cleaner, and so forth), an artificial intelligence robot, a TV, a digital Video Disk (DVD) player, an audio equipment, various medical instruments (for example, Magnetic Resonance Angiography (MRA), Magnetic Resonance Imaging (MRI), Computed Tomography (CT), a scanning machine, an ultrasound machine, and so forth), a navigation system, a Global Positioning System (GPS) receiver, an Event Data Recorder (EDR), a Flight Data Recorder (FDR), a set-top box, a TV box (for example, Samsung HomeSync™, Apple TV™, or Google TV™), an electronic dictionary, a vehicle infotainment device, an electronic equipment for ships, such as a navigation device for ships or a gyro compass, an avionics device, a security device, electronic clothes, an electronic key, a camcorder, a game console, a Head-Mounted Display (HMD), a flat panel display device, an electronic frame, an electronic album, furniture or a portion of a building/structure having a communication function, an electronic board, an electronic signature receiving device, a wearable device, and a projector. It is obvious to those of ordinary skill in the art that the electronic device according to various embodiments of the present invention is not limited to the above-described devices.

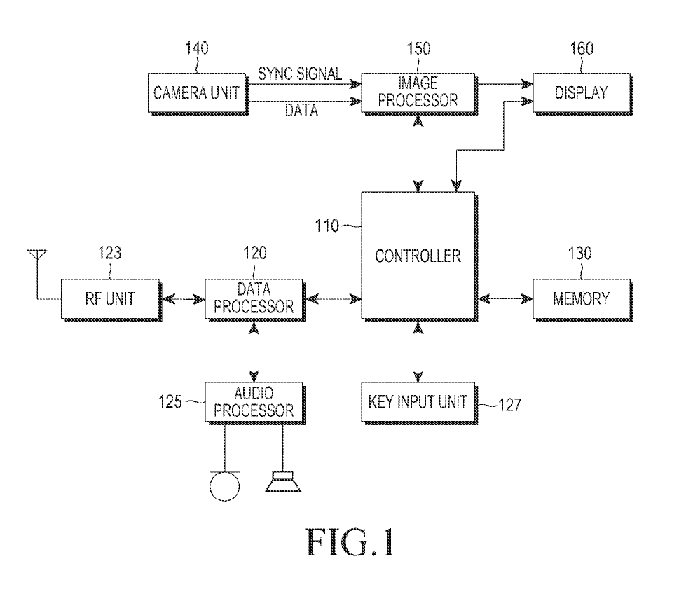

FIG. 1 illustrates an electronic device 100 according to an embodiment of the present invention.

Referring to FIG. 1, a Radio Frequency (RF) unit 123 performs a radio communication function of the electronic device 100. The RF unit 123 includes an RF transmitter for up-converting a frequency of a transmission signal and amplifying the transmitted signal and an RF receiver for low-noise amplifying a received signal and down-converting the frequency of the received signal. A data processor 120 includes a transmitter for encoding and modulating the transmission signal and a receiver for demodulating and decoding the received signal. The data processor 120 may include a modem and a codec. Herein, the codec includes a data codec for processing packet data and an audio codec for processing an audio signal such as a voice. An audio processor 125 reproduces a received audio signal being output from the audio codec of the data processor 120 or transmits a transmission audio signal generated from a microphone to the audio codec of the data processor 120.

A key input unit 127 includes keys for inputting numeric and character information and functional keys for setting various functions. The key input unit 127 may be a touch screen, a capacitive touch panel, and a resistive touch panel for a software key input as well as for a hardware key input, or a hardware device for sensing a hovering input or a pen input.

A memory 130 includes program and data memories. The program memory stores programs for controlling a general operation of the electronic device 100, and programs for generating a layer for displaying data of a first region of a display 160 in a first mode, displaying the generated layer on a second region of the display 160, and identically applying an event occurring on the layer to the first region of the display 160. The data memory may temporarily store data generated during execution of the programs. The layer described below according to various embodiments of the present invention intends to display data on a particular region of the display 160 and may be described as, but not limited to, a window or an object.

The controller 110 controls the overall operations of the electronic device 100.

According to an embodiment of the present invention, in a first mode in which the display 160 is divided into a first region and a second region, the controller 110 displays a layer for displaying data of the first region on the second region.

According to an embodiment of the present invention, if a particular gesture occurs in a second mode, the controller 110 switches to the first mode to deactivate an input function with respect to the first region of the display 160, activates a display function with respect to the first region of the display 160, and displays the layer for displaying data of the first region overlapping on the second region of the display 160.

The particular gesture that causes switchover from the second mode to the first mode may be a scrolling action, and if the scrolling action occurs once or twice consecutively during a predetermined period, the first region and the second region of the display 160 may be determined according to a direction in which the scrolling action occurs when screen scrolling (or screen movement) corresponding to the scrolling action is not performed.

For example, if a scroll-down action occurs on the display 160 in the second mode, when screen scrolling on the display 160 corresponding to the scroll-down action is not performed, the controller 110 determines an upper region of the display 160 as a first region and a lower region of the display 160 as a second region and switches to the first mode. The controller 110 generates a layer for displaying data of the upper region of the display 160 and displays the layer on the lower region of the display 160 in the first mode.

If a scroll-up action occurs on the display 160 in the second mode, when screen scrolling on the display 160 corresponding to the scroll-up action is not performed, the controller 110 determines the lower region of the display 160 as the first region and the upper region of the display 160 as the second region and switches to the first mode. In the first mode, the controller 110 generates a layer for displaying data of the lower region of the display 160 and displays the generated layer on the upper region of the display 160.

If a scroll-right action occurs on the display 160 in the second mode, when screen scrolling on the display 160 corresponding to the scroll-right action is not performed, the controller 110 determines a left region of the display 160 as the first region and a right region of the display 160 as the second region and switches to the first mode. In the first mode, the controller 110 generates a layer for displaying data of the left region of the display 160 and displays the generated layer on the right region of the display 160.

If a scroll-left action occurs on the display 160 in the second mode, when screen scrolling on the display 160 corresponding to the scroll-left action is not performed, the controller 110 determines the right region of the display 160 as the first region and the left region of the display 160 as the second region and switches to the first mode. In the first mode, the controller 110 generates a layer for displaying data of the right region of the display 160 and displays the generated layer on the left region of the display 160.

In various embodiments of the present invention, the particular gesture for switching the second mode to the first mode may include not only a scroll action in a particular direction and various gestures such as a long touch, a double touch, and so forth, but also the direction change or various movements of the electronic device 100.

According to an embodiment of the present invention, if an input event occurs on the layer in the first mode, the controller 110 switches to the second mode in which the layer is not displayed, and displays the data based on an action corresponding to the input event on the display 160 in the second mode. The second mode is switched from the first mode when the layer is not displayed and an input function is activated. The second mode is not divided into a first region and a second region in the display 160.

For example, if a touch event occurs on the layer in the first mode and thus screen switchover is executed, the controller 110 may switch to the second mode in which the layer is not displayed, and display data of the screen switched corresponding to the touch event on the display 160 in the second mode.

If a touch event occurs on a search window displayed on the layer in the first mode, the controller 110 switches to the second mode and displays a key input unit on the display 160 in the second mode.

According to an embodiment of the present invention, if an input event occurs on the layer in the first mode, the controller 110 displays an operation corresponding to the input event on at least one of the layer or the display 160.

For example, if a scroll-left/right event occurs on the layer and thus screen switchover is executed in the first mode, the controller 110 may display data of the screen switched corresponding to the scroll-left/right event on at least one of the layer and the display 160.

According to an embodiment of the present invention, if the particular gesture occurs on the layer in the first mode, the controller 110 switches to the second mode in which the layer is not displayed.

According to an embodiment of the present invention, the controller 110 divides the display 160 into the first region and the second region and displays the data, which is displayed in the first region, on the second region. The controller 110 then displays the data corresponding to an input on the second region on the display 160 which is not divided into the first region and the second region.

The controller 110 may divide the display 160 into the first region and second region, and display according to generation of a particular input on the display 160 or default settings.

The display 160 may use a Liquid Crystal Display (LCD), and in this case, the display 160 may include an LCD controller, a memory capable of storing image data, and an LCD display device. Herein, if the LCD is implemented with a touch screen, it may operate as an input unit and in this case, the display 160 may display keys such as the key input unit 127.

If the display 160 implemented with a touch screen is used as a touch screen unit, the touch screen unit includes a Touch Screen Panel (TSP) including a plurality of sensor panels which include a capacitive sensor panel capable of recognizing a hand touch and an electromagnetic induction sensor panel capable of sensing a fine touch such as a touch pen.

According to an embodiment of the present invention, in the first mode in which the display 160 is divided into the first region and the second region, the layer for displaying the data of the first region may be displayed on the second region.

A camera unit 140 includes a camera sensor for capturing image data and converting the captured optical image signals into electrical image signals, and a signal processor for converting analog image signals captured by the camera sensor into digital image data. The camera sensor is assumed to be a Charge-Coupled Device (CCD) or Complementary Metal-Oxide Semiconductor (CMOS) sensor, and the signal processor may be implemented with a Digital Signal Processor (DSP). The camera sensor and the signal processor may be implemented integrally or separately.

An image processor 150 performs Image Signal Processing (ISP) to display the image signals output from the camera unit 140 on the display 160. The ISP includes gamma correction, interpolation, spatial variation, image effects, image scaling, Auto White Balance (AWB), Auto Exposure (AE), Auto Focus (AF) and the like. The image processor 150 processes the image signals output from the camera unit 140 on a frame basis, and outputs frame image data according to the characteristics and size of the display 160. The image processor 150, which includes a video codec, compresses the frame image data displayed on the display 160 and decompresses (or restores) the compressed frame image data to its original frame image data, using a set coding scheme. The video codec may be a Joint Photographic Experts Group (JPEG) codec, a Moving Picture Experts Group 4 (MPEG4) codec, a Wavelet codec, or the like. The image processor 150 is assumed to have an On Screen Display (OSD) function, and may output OSD data depending on the size of the displayed screen under the control of the controller 110.

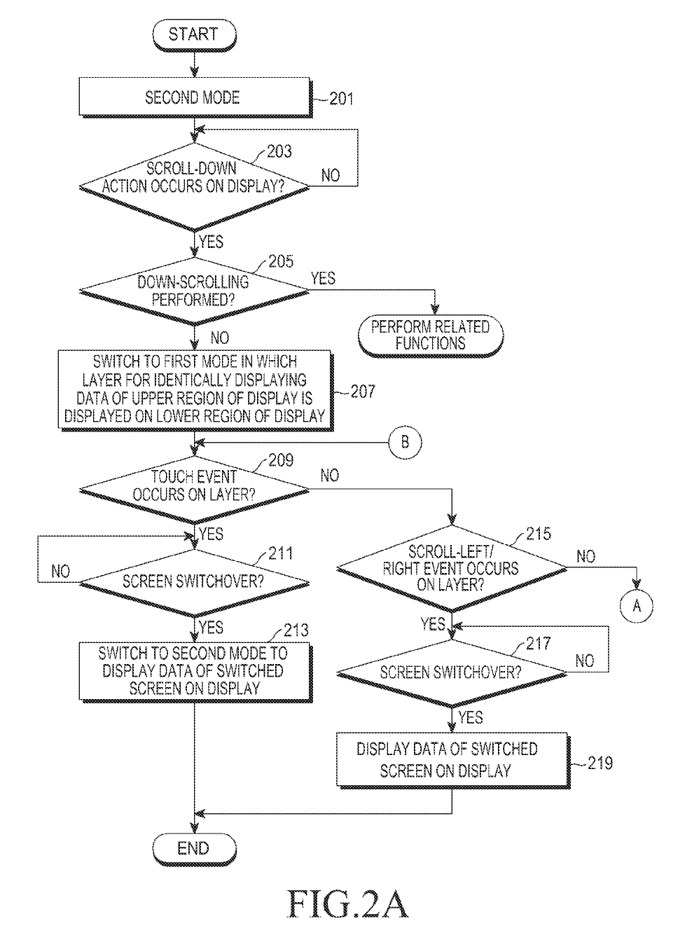

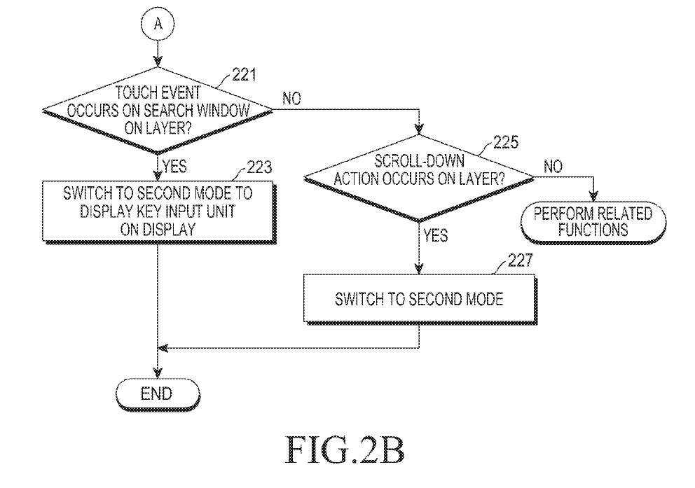

With reference to FIGS. 2A through 7B, a process of providing a User Interface (UI) in the electronic device 100, as described above, will be described in detail.

While a description is made using an example in which a particular gesture for switching to the first mode is a scroll-down action in FIGS. 2A through 7B, the description may be identically applied to a scroll-up action, a scroll-right action, and a scroll-left action.

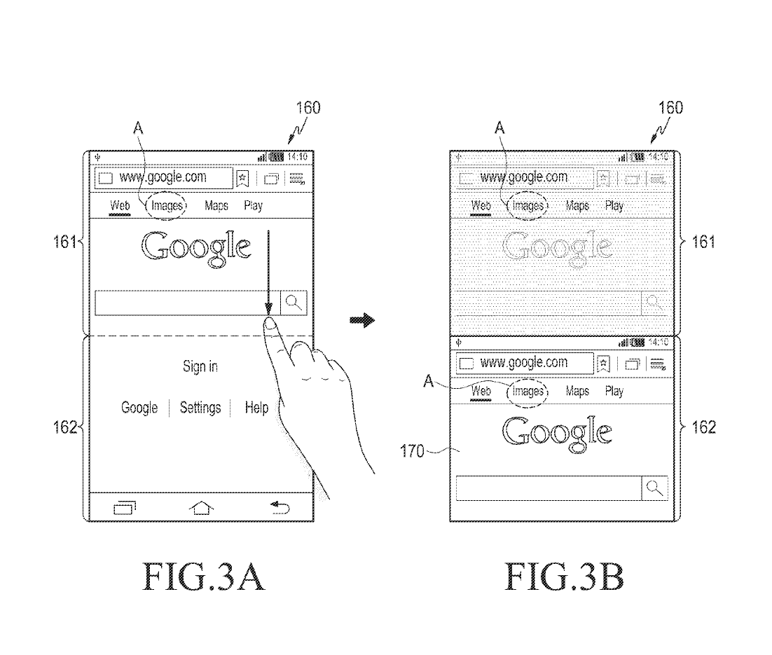

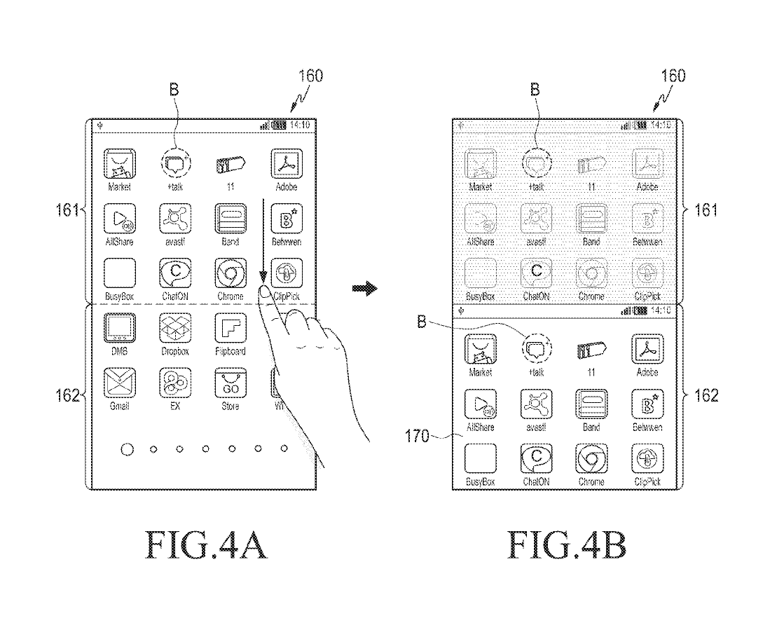

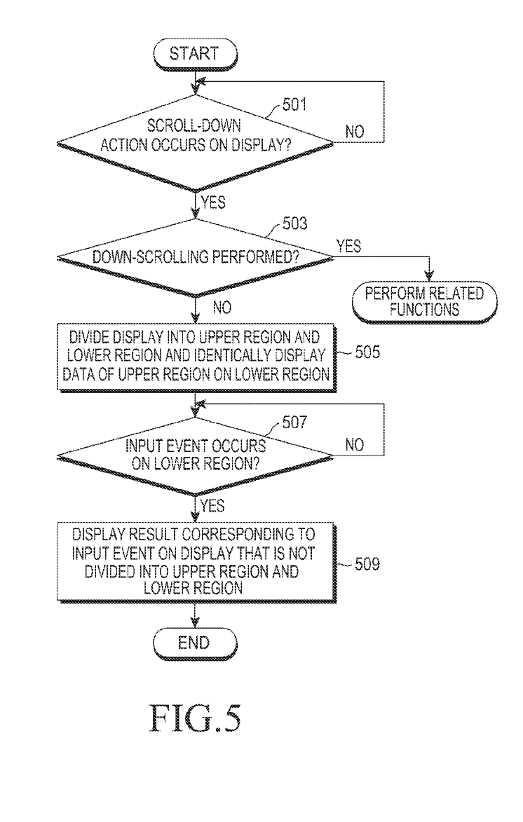

FIGS. 2A and 2B are flowcharts illustrating a process of providing a UI in the electronic device 100 according to an embodiment of the present invention. FIGS. 3A and 3B illustrate a process of providing a UI on a web page screen of the electronic device 100 according to an embodiment of the present invention. FIGS. 4A and 4B illustrate a process of providing a UI on a menu screen of the electronic device 100 according to an embodiment of the present invention.

Referring to FIGS. 2A and 2B, in step 201, when the second mode in which data is displayed on the display 160, the controller 110 may perform step 203 to determine whether a scroll action occurs on the display 160.

In step 203, if the controller 110 senses the scroll-down action occurring on the display 160, the controller 110 determines whether screen scrolling on the display 160 corresponding to the scroll-down action is performed in step 205.

If screen scrolling on the display 160 corresponding to the scroll-down action is not performed in step 205, the controller 110 determines the upper region of the display 160 as the first region and the other region of the display 160 rather than the first region as the second region, and performs step 207 for switchover to the first mode. In step 207, the controller 110 generates a layer for displaying identical data of the upper region of the display 160 and displays the layer overlapping on the lower region of the display 160. In step 207, when the layer is displayed overlapping on the lower region of the display 160, the controller 110 deactivates an input function with respect to the upper region of the display 160 and activates a display function with respect to the upper region of the display 160. As the input function related to the upper region of the display 160 is deactivated, a user's input action may be performed only on the layer displayed on the lower region of the display 160.

In step 207, the screen of the display 160 may display a background, the layer may be displayed as a foreground, and the upper region of the display 160 may be shaded and displayed dimly.

The controller 110 determines whether at least one of a touch event, a scroll-left/right event, a touch event on a search window, or scroll-down actions occurs on the layer in the first mode.

In step 209, the controller 110 determines whether the touch event occurs on the layer in the first mode. If the touch event occurs, the controller 110 determines whether screen switchover is executed in step 211. If screen switchover is executed, the controller 110 performs step 213 for switchover to the second mode. In step 213, the controller 110 switches to the second mode in which the layer is not displayed on the display 160 and an input function of the display 160 is activated. In the second mode, the controller 110 may display data of the screen switched corresponding to the touch event.

Coordinates corresponding to the touch event occurring on the layer used to display the upper region of the display 160 may be identically applied to and displayed on the upper region of the display 160.

In step 215, the controller 110 determines whether the scroll-left/right event occurs on the layer in the first mode. If the scroll-left/right event occurs on the layer, the controller 110 determines whether screen switchover corresponding to the scroll-left/right event is executed in step 217. If screen switchover is executed, the controller 110 displays data of the switched screen on the layer in step 219.

In step 221, if the controller 110 determines that the touch event occurs on a search window displayed on the layer in the first mode, the controller 110 switches to the second mode to display a key input unit on a predetermined region of the display 160, for example, the lower region of the display 160, in step 223.

In step 225, if the controller 110 determines that one, or two consecutive, scroll-down actions occur on the layer in a predetermined period in the first mode, the same as in step 203, the controller 110 switches to the second mode in which the layer is not displayed in step 227.

Referring to FIG. 3A, in the second mode, when a web page is displayed on the display 160, if the scroll-down action occurs on the display 160 with the intent to select an item “A”, but screen scrolling corresponding to the scroll-down action is not performed because the display 160 displays the topmost screen image of the web page, then the controller 110 may switch to the first mode in which the layer is displayed as illustrated in FIG. 3B.

In the first mode as illustrated in FIG. 3B, the controller 110 generates a layer 170 that displays identical data of an upper region 161 of the display 160, displays the generated layer 170 on a lower region 162 of the display 160, deactivates an input function with respect to the upper region 161 of the display 160, and activates the input function with respect to the layer 170.

If a touch event occurs with respect to the item “A” displayed on the layer 170 in the first mode as illustrated in FIG. 3B, and if screen switchover from the first mode to the second mode corresponding to the touch event with respect to the item “A” is performed, then the controller 110 displays data of the switched screen on the display 160 in the second mode in which the layer 170 is not displayed as illustrated in FIG. 3A.

Referring to FIG. 4A, in the second mode, if a scroll-down action occurs on the display 160 to select a menu item “B” when a plurality of menus of the electronic device 100 is displayed on the display 160, then controller 110 switches to the first mode in which the layer 170 is displayed as illustrated in FIG. 4B.

In the second mode as illustrated in FIG. 4A, if screen scrolling corresponding to a scroll-up/down action is not performed, the controller 110 does not need to detect the screen scrolling.

In the first mode as illustrated in FIG. 4B, the controller 110 generates the layer 170 for displaying identical data of the upper region 161 of the display 160, displays the generated layer 170 on the lower region 162 of the display 160, deactivates an input function with respect to the upper region 161 of the display 160, and activates the input function with respect to the layer 170.

In the first mode as illustrated in FIG. 4B, if a touch event with respect to the menu item “B” displayed on the layer 170 occurs, and if an application corresponding to the menu item “B” is executed upon occurrence of the touch event with respect to the menu item “B”, then the controller 110 displays the executed application on the display 160 in the second mode in which the layer 170 is not displayed as illustrated in FIG. 4A.

FIG. 5 is a flowchart illustrating a process of providing another UI in the electronic device 100 according to an embodiment of the present invention.

Referring to FIG. 5, during displaying data on the display 160, the controller 110 determines whether a scroll-down action occurs on the display 160 in step 501.

If the controller 110 senses the scroll-down action occurring on the display 160 in step 501, the controller 110 determines whether screen scrolling on the display 160 corresponding to the scroll-down action is performed in step 503.

If screen scrolling on the display 160 corresponding to the scroll-down action is not performed in step 503, the controller 110 displays the upper region of the display 160 as the first region and the other region rather than the first region as the second region and then displays identical data, which is displayed on the upper region, on the lower region in step 505. The upper region and the lower region may be displayed using different effects, such as shading.

The controller 110 determines whether an input event occurs on the lower region in step 507. In step 509, the controller 110 displays the data corresponding to the input event on the entire display 160 which is not divided into the upper region and the lower region.

A criterion for dividing the upper region and the lower region may be set at the time of manufacturing of the electronic device 100 or may be set by a user.

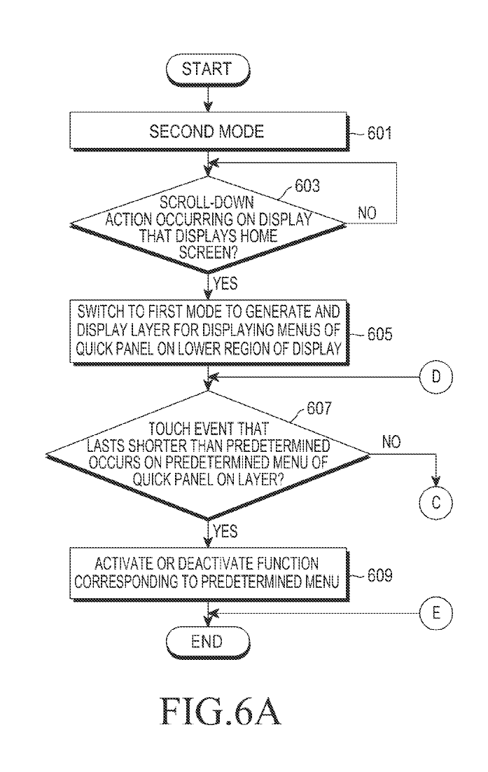

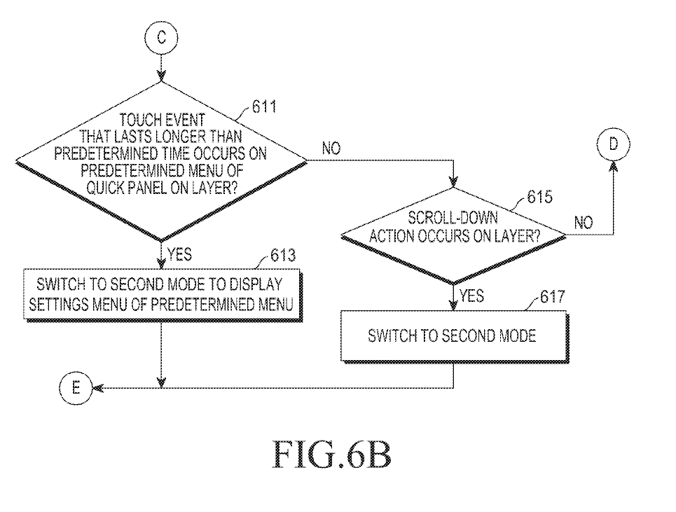

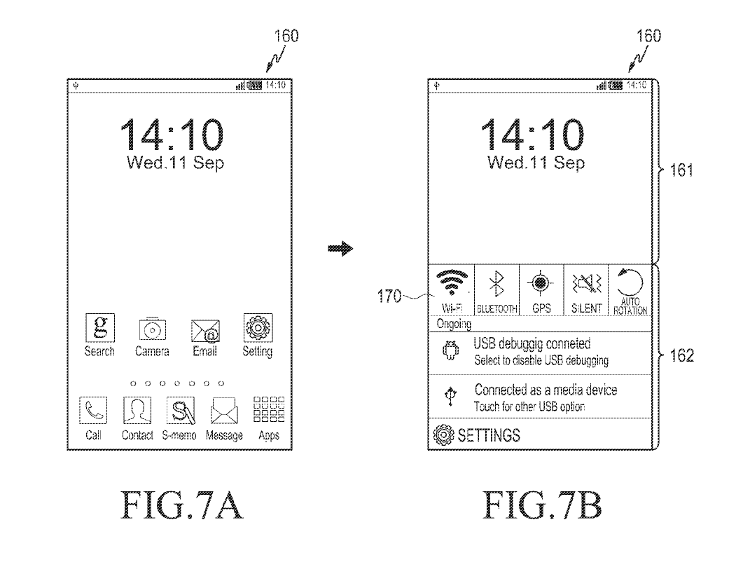

FIGS. 6A and 6B are flowcharts illustrating a process of providing a menu of a quick panel on a UI in the electronic device 100 according to an embodiment of the present invention. FIG. 7A and illustrate a process of providing a menu of a quick panel on a UI in the electronic device 100 according to an embodiment of the present invention.

Referring to FIGS. 6A and 6B, in step 601, when a second mode in which a home screen is displayed on the display 160, the controller 110 determines whether a scroll-down action occurs on the display 160 in step 603.

If the controller 110 senses the scroll-down action occurring on the display 160 in step 603, the controller 110 switches to a first mode, generates a layer for displaying identical menus of a quick panel provided on the home screen, and displays the generated layer on the lower region 162 of the display 160, in step 605.

The quick panel is displayed in the upper region of the display on the home screen and the content of the panel is displayed in the drop-down menu. The quick panel includes a Wi-Fi activation/deactivation menu, a Bluetooth activation/deactivation menu, a Global Positioning System (GPS) activation/deactivation menu, and so forth.

If the controller 110 determines that a touch event lasts shorter than the predetermined time with respect to a corresponding menu among the menus of the quick panel displayed on the generated layer in step 607, then the controller 110 activates or deactivates a function corresponding to the corresponding menu on which the touch event occurs in step 609.

If the controller 110 determines that a touch event that last longer than the predetermined time occurs with respect to a corresponding menu among the menus of the quick panel displayed on the generated layer in step 609, then the controller 110 switches to the second mode in which the layer is not displayed and displays a settings menu of the corresponding menu on which the touch event occurs in the second mode in step 617.

If the controller 110 determines that the scroll-down action occurs on the layer in step 615, the controller 110 switches to the second mode in which the layer that displays the menus of the quick panel is not displayed in step 617.

In the second mode as illustrated in FIG. 7A, if the scroll-down action occurs on the display 160 that displays a home screen, the controller 110 switches to the first mode in which the layer 170 as illustrated in FIG. 3B is displayed.

If the scroll-down action occurs on the display 160 that displays a home screen, the menus of the quick panel provided on the upper region 161 of the display 160 of the home screen may be provided on the layer 170 displayed on the lower region 162 of the display 160 as illustrated in FIG. 7B, such that the user who controls the electronic device 100 with one hand may conveniently select the menus of the quick panel.

The electronic device and method for providing the UI in the electronic device according to various embodiments of the present invention can be embodied as a computer-readable code on a computer-readable recording medium. The computer-readable recording medium is any data storage device that can store data which can be thereafter read by a computer system. Examples of computer-readable recording media include read-only memory (ROM), random-access memory (RAM), optical disks, magnetic tapes, floppy disks, hard disks, non-volatile memories, etc., and carrier waves (e.g., transmission through the Internet). The computer-readable recording medium can also be distributed over network-coupled computer systems so that the computer-readable code is stored and executed in a decentralized fashion.

As is apparent from the foregoing description, the electronic device and the method for providing a UI in the electronic device according to various embodiments of the present invention may allow a user to easily search for data with one hand using the electronic device.

While the present invention has been particularly illustrated and described with reference to embodiments thereof, various modifications or changes can be made without departing from the scope of the present invention. Therefore, the scope of the present invention is not limited to the described embodiments, and should be defined by the scope of the following claims and any equivalents thereof.

What is claimed is:

1. An electronic device comprising:
an inputtable display that is divided into a first region and a second region in a first mode in which a layer for displaying data of the first region is displayed on the second region; and
a controller configured to identically apply an event occurring on the layer to the first region of the display, upon occurrence of the event on the layer.

2. The electronic device of claim 1, wherein if a particular gesture occurs in a second mode, the controller switches to the first mode, deactivates an input function with respect to the first region of the display, and displays the layer overlapping on the second region of the display in the first mode.

3. The electronic device of claim 2, wherein if down-scrolling is not performed on the display even though a scroll-down action occurs on the display in the second mode, the controller switches to the first mode and displays the layer on a lower region of a screen in the first mode.

4. The electronic device of claim 2, wherein if up-scrolling on the display is not performed even though a scroll-up action occurs on the display in the second mode, the controller switches to the first mode and displays the layer on an upper region of a screen in the first mode.

5. The electronic device of claim 1, wherein if an input event occurs on the layer, the controller switches to the second mode in which the layer is not displayed, and displays an operation corresponding to the input event on the display in the second mode.

6. The electronic device of claim 5, wherein if an input event occurs on the layer and screen switchover is executed, the controller switches to the second mode in which the layer is not displayed, and displays data of a screen switched corresponding to the input event on the display in the second mode.

7. The electronic device of claim 5, wherein if an input event occurs on a search window displayed on the layer, the controller switches to the second mode in which the layer is not displayed, and displays a key input unit on the display in the second mode.

8. The electronic device of claim 1, wherein if an input event occurs on the layer, the controller displays an operation corresponding to the input event on at least one of the layer and the display.

9. The electronic device of claim 8, wherein if a scroll-left/right event occurs on the layer and thus screen switchover is executed, the controller displays data of a screen switched corresponding to the scroll-left/right event on at least one of the layer and the display.

10. The electronic device of claim 1, wherein if a particular gesture occurs on the layer, the controller switches to the second mode in which the layer is not displayed.

11. An electronic device comprising:
a display having an input function; and
a controller configured to divide the display into a first region and a second region, display data, which is displayed on the first region, on the second region, and display data corresponding to an input on the second region on the display.

12. The electronic device of claim 11, wherein the controller divides the display into the first region and the second region upon occurrence of a particular input on the display or according to default settings, and displays the data corresponding to the input on the second region on the entire display that is not divided into the first region and the second region.

13. A method for providing a User Interface (UI) in an electronic device, the method comprising:
displaying, in a first mode in which a display is divided into a first region and a second region, a layer for displaying data of the first region on the second region; and
identically applying an event occurring on the layer on the first region of the display, upon occurrence of the event on the layer.

14. The method of claim 13, wherein displaying the layer comprises:
switching to the first mode upon occurrence of a particular gesture in a second mode;
deactivating an input function with respect to the first region of the display; and
displaying the layer overlapping on the second region of the display in the first mode.

15. The method of claim 14, further comprising:
switching to the first mode if down-scrolling on the display is not performed even though a scroll-down action occurs on the display in the second mode; and
displaying the layer on a lower region of the screen in the first mode.

16. The method of claim 14, further comprising:
switching to the first mode if up-scrolling on the display is not performed even though a scroll-up action occurs on the display in the second mode; and
displaying the layer on an upper region of the screen in the first mode.

17. The method of claim 13, wherein identically applying the event comprises:
switching to a second mode in which the layer is not displayed, if an input event occurs on the layer; and
displaying an operation corresponding to the input event on the display in the second mode.

18. The method of claim 17, further comprising:
switching to the second mode in which the layer is not displayed, if an input event occurs on the layer and screen switchover is executed; and
displaying data of a screen switched corresponding to the input event on the display in the second mode.

19. The method of claim 17, further comprising:
switching to the second mode in which the layer is not displayed, upon occurrence of an input event on a search window displayed on the layer; and
displaying a key input unit on the display in the second mode.

20. The method of claim 13, wherein identically applying the event comprises displaying an operation corresponding to the input event on at least one of the layer and the display.

21. The method of claim 20, further comprising displaying data of a screen switched corresponding to a scroll-left/right event on at least one of the layer and the display, if the scroll-left/right event occurs on the layer and screen switchover is executed.

22. The method of claim 13, further comprising switching to a second mode in which the layer is not displayed, upon occurrence of a particular gesture on the layer.

23. A method for providing a User Interface (UI) in an electronic device, the method comprising:
displaying data, which is displayed on a first region, on a second region when a display is divided into and displayed as the first region and the second region; and
displaying on the display data corresponding to an input on the second region.

24. The method of claim 23, wherein the display divided into and displayed as the first region and the second region upon occurrence of a particular input through the display or according to default settings, and
wherein the data corresponding to the input on the second region is displayed on the entire display which is not divided into the first region and the second region.
